(19) United States
(12) Patent Application Publication
(10) Pub. No.: US 2002/0061003 A1
(43) Pub. Date: May 23, 2002

(54) Method of and system for wireless network access through server platform integration

(75) Inventors: Terence Edward Sumner, Rowlett, TX (US); Mark Simmons, Madison, MS (US); James Rodts, Southlake, TX (US); Mark L. Witsaman, Southlake, TX (US); Michael L. Smith, Monticello, MS (US); Demitrius Nelon, Watauga, TX (US); William Tartaglia, Flower Mound, TX (US)

Correspondence Address: Stanley R. Moore, Esq., Jenkens & Gilchrist, P.C., Suite 3200, 1445 Ross Avenue, Dallas, TX, 75202-2799, US

(73) Assignee: ARCH WIRELESS, INC.

(21) Appl. No.: 10/040,165

(22) Filed: Oct. 22, 2001

Related U.S. Application Data
(60) Provisional application No. 60/242,562, filed on Oct. 23, 2000.

(51) Int. Cl. H04L 12/56; H04L 12/28; H04Q 7/24

(52) U.S. Cl. 370/338; 370/401

(57) ABSTRACT

A method, system, and apparatus for incorporating a database-enabled server into a wireless network. The method includes the steps of receiving, at the wireless gateway, a communication message from a first communication network, the communication message including address information associated with a subscriber; storing, by the wireless gateway, the communication message, the communication message being stored in association with the subscriber; and selectively sending, with the wireless gateway using the wireless communication network, at least a portion of the communication message to a wireless device.

### BACKGROUND OF THE INVENTION

1. Technical Field of the Invention

The present invention relates to messaging systems, and, more specifically to a method, system, and apparatus for incorporating, but not by way of limitation, a database-enabled server into a wireless network.

2. Description of Related Art

In recent years, the use of wireless paging networks has increased in popularity. Conventional wireless paging networks, telephone callers, PC users and mobile device subscribers can

In subsequent systems, stand-alone alphanumeric interface devices, such as the Alphamate™, or PCs running specialized access software, were able to send messages directly to the network. These devices would gain access to the network through a dial-up modem connection. Paging carriers, as an industry, developed a standard for this type of access called TAP (Telocator Access Protocol). The dial-in data connection was maintained only long enough to submit the message. No method for responses was possible, even if the device received the message quickly and responded immediately, although the vast majority of devices were not capable of responding.

The major drawbacks to these systems were that the devices, such as the Alphamate™, were expensive, PCs were not always readily available and the configuration process of the specialized software was difficult.

Today many carriers are in the process of merging their wireless networks with the Internet because the Internet provides a convenient medium for sending wireless messages. With the popularity of the Internet and the World Wide Web, alphanumeric access has been vastly simplified. As a result, alphanumeric display paging use has increased relative to the standard numeric display paging. The predominant methods of sending messages on the Internet are through Web pages and e-mail. By going to the paging provider's Web page, alphanumeric messages can be sent directly to a subscriber's pager.

In one implementation of wireless paging, PC users access a particular Web page at a given Uniform Resource Locator (URL) belonging to the wireless network provider, and click through to a messaging page that allows the user to enter the phone number functioning as an identifier of the subscriber they are trying to page. Some systems may permit a user-friendly name or alias to be used instead of, or in addition to, the phone number to identify the pager. Since messages submitted this way through the Web site are on dynamic connections, return messages are difficult to route back to the user. One method used for routing return messages is a tracking number that the network supplies in response to a message submission. The user can connect to the Web site again, type in the tracking number, and see if the message was properly delivered. Alternatively, the user may input an e-mail address to which responses may be sent.

A second method of wireless paging is through the use of SMTP (Simple Mail Transport Protocol) or e-mail. PC users can send e-mail to an address for the pager in a format such as phone-number@network or alias@network. This is similar to the entry via a Web page. If the e-mail method is used, the return address can be a valid e-mail address.

The most straightforward implementation of Internet gateways is the SMTP or e-mail gateway. In most of these implementations e-mail is received by the gateway and then sent to the wireless device. If the device does not exist, there is no intelligence in the gateway to pass this information back to the sender. In these traditional systems messages are simply passed from the gateway to the network without benefit of any value-added applications.

A final method for wireless paging is to establish a direct connection, most commonly a “socket” connection, through the paging company's Internet address, and send a message directly from a client application. A problem with these methods is that the pager acts as a remote device to an existing Internet application and is not easily tailored to the Internet

In order for PC-based client forwarding of e-mail through an e-mail gateway to function, the PC must be turned on and have a permanent connection to the Internet. Some of the more sophisticated corporate servers incorporate server-based applications that forward messages to the gateways. Although these systems do not have the inherent limitations of the PC client-based solution, the forwarding software must still be run on corporate servers which few people outside of corporate environments have access to. This leaves the majority of people, such as those with dial-up accounts, with no easy solution to this problem.

Traditional Hypertext Transfer Protocol (HTTP) Web sites for submitting messages to wireless subscribers do not offer much help. Most of these sites do nothing but accept messages and then forward them to the device. Again there is no confirmation to the user that a message has been sent and there is no way to reply to a Web site for two-way messaging.

In the future new Internet-based protocols are being developed so that two-way data applications will be enabled through the wireless network. One of the key protocols for the two-way messaging industry is the Wireless Communication Transfer Protocol (WCTP). WCTP is aimed at creating a standard for passing alphanumeric and binary messages between wireline systems and wireless devices, including two-way capable wireless devices. This new protocol is based upon Extensible Markup Language (XML) and HTTP. Unfortunately, the current state of commercial gateways will again limit the usefulness of this protocol, and wireless data devices in general.

As two-way paging becomes more dominant, problems with traditional methods are going to become more apparent. In the two-way world, the problem of “replying to” becomes more acute than just sending out a message from the pager. There are numerous problems with the traditional methods. Dispatch operators or TAP provide strictly one-way environments in which there is no clean way to respond to messages. Web-based paging can establish a two-way connection to a chat service on the Internet, but protocols for instant messaging (IM) are somewhat inefficient for wireless transport and do not inter-operate well with e-mail addressees. Thus, what is needed is a method to reduce the inefficiencies in message transfer to wireless devices, provide services tailored for wireless devices, and improve the reliability of applications for wireless devices, while maintaining the ability for interoperation with standard Internet applications.

### SUMMARY OF THE INVENTION

The present invention relates to a method of and system for wireless network access through server platform integration. More particularly, one aspect of the invention comprises a method for operating a wireless gateway. The method includes receiving, at the wireless gateway, a communication message from a first communication network. The communication message includes address information associated with a subscriber. The method further includes storing the communication message by the wireless gateway, the communication message being stored in association with the subscriber. The method further includes selectively sending, with the wireless gateway using the wireless communication network, at least a portion of the communication message to a wireless device.

Another aspect of the present invention comprises a wireless messaging system including a first communication network, a wireless communication network, and a wireless gateway in communication with the first communication network and the wireless communication network. The wireless gateway receives, from the first network, a communication message including address information associated with a subscriber. The wireless gateway has a database which stores the communication message in association with the subscriber. The wireless gateway is further capable of selectively sending at least a portion of the communication message to a wireless device using the wireless communication network.

Still another aspect of the present invention comprises an apparatus for wireless messaging including a first interface in communication with a first communication network, a second interface in communication with a wireless communication network, and a wireless gateway in communication with the first interface and the second interface. The wireless gateway receives, from the first interface, a communication message including address information associated with a subscriber. The wireless gateway has a database which stores the communication message in association with the subscriber. The wireless gateway is further capable of selectively sending at least a portion of the communication message to a wireless device using the wireless communication network.

An advantage of the present invention is that it provides for a more efficient usage of wireless network resources during wireless messaging.

An additional advantage of the present invention is that a wireless subscriber no longer needs to maintain a client-side messaging server and database.

### BRIEF DESCRIPTION OF THE DRAWINGS

For a more complete understanding of the present invention, reference is made to the following detailed description taken in conjunction with the accompanying drawings wherein:

FIG. 1 is a block diagram of a traditional paging network 100;

FIG. 2 is a block diagram of a traditional two-way messaging system 200;

FIG. 3 is a block diagram of a wireless messaging system 300 in accordance with an embodiment of the present invention;

FIG. 4 is a block diagram of a wireless messaging system 400 in accordance with another embodiment of the present invention; and

FIG. 5 is a block diagram of a light-client system 500 in accordance with the present invention.

### DETAILED DESCRIPTION OF THE INVENTION

A solution to the problems presented by traditional wireless messaging systems in accordance with the present invention is through the use of a wireless messaging engine (WME)with an integrated database that is continuously connected to the Internet. Efficiency over the wireless network can be maintained at a high level by filtering out of unnecessary information and maintenance of state and threading information within the engine and database rather than at the device. The communications with the device can be tailored to the device characteristics to tie the device more closely to Internet applications.

Reference is now made to the Drawings wherein like reference characters denote like or similar parts throughout the various Figures.

Referring now to FIG. 1, a block diagram of a traditional paging network 100 is shown. In a traditional paging network 100, a message originator 110, for example, a telephone caller, a PC user, a mobile user, or information source, generates a message intended for a particular wireless device 140a-140c. The message is received at a traditional gateway 120a-120d which sends the message to a wireless network 130, with the message originator 110 or a proxy for the message originator 110 optionally being authenticated. The wireless network 130 then sends the message to the particular wireless device 140a-140c for which the message is intended. The traditional gateways 120a-120d act as simple portals to the wireless network 130 and take the form of a variety of implementations using various protocols.

A telephone gateway 120a is used to receive messages from a message originator 110 that dials in via a modem or telephone. The message originator 110 provides a telephone number or PIN associated with the wireless device 140a-140c. The telephone gateway 120a is configured to receive messages using an appropriate format or protocol, for example, a DTMF or TAP protocol. Inmost network implementations, a telephone gateway 120a is incorporated that accepts both the DTMF format and the TAP protocol. In this implementation received data is either accepted or rejected by the telephone gateway 120a, and then sent to the wireless network 130. The wireless network 130 then sends the message to the wireless device 140a-140c. However, TAP has never been fully developed for two-way message communication applications.

Another common gateway is a Web page gateway 120b. A message originator 110 generates a message using a Web site which is sent to the Web page gateway 120b via HTTP. The Web page gateway 120b sends the message to the wireless network 130, which sends the message to the wireless device 140a-140c using the wireless interface 135a-135c. However, this and other less pervasive methods of messaging from the Internet to a wireless device are all simple gateway-based implementations.

Still another common gateway is an e-mail gateway 120c. In this implementation, a message originator 110 generates a message with an e-mail address or alias associated with a wireless device 140a-140c. The message is sent to the e-mail gateway 120c using Simple Mail Transport Protocol (SMTP). The e-mail message is received at the e-mail gateway 120c and then sent to the wireless network 130. The wireless network 130 then sends the message to the wireless device 140a-140c associated with the e-mail address or alias.

Still another type of gateway is the Wireless Communications Transfer Protocol (WCTP) gateway 120d. A message originator 110 generates a message which is sent to the WCTP gateway 120d in WCTP's XML format over HTTP. The WCTP gateway 120d sends the message to the wireless network 130. The wireless network then sends the message to the wireless device 140a-140c.

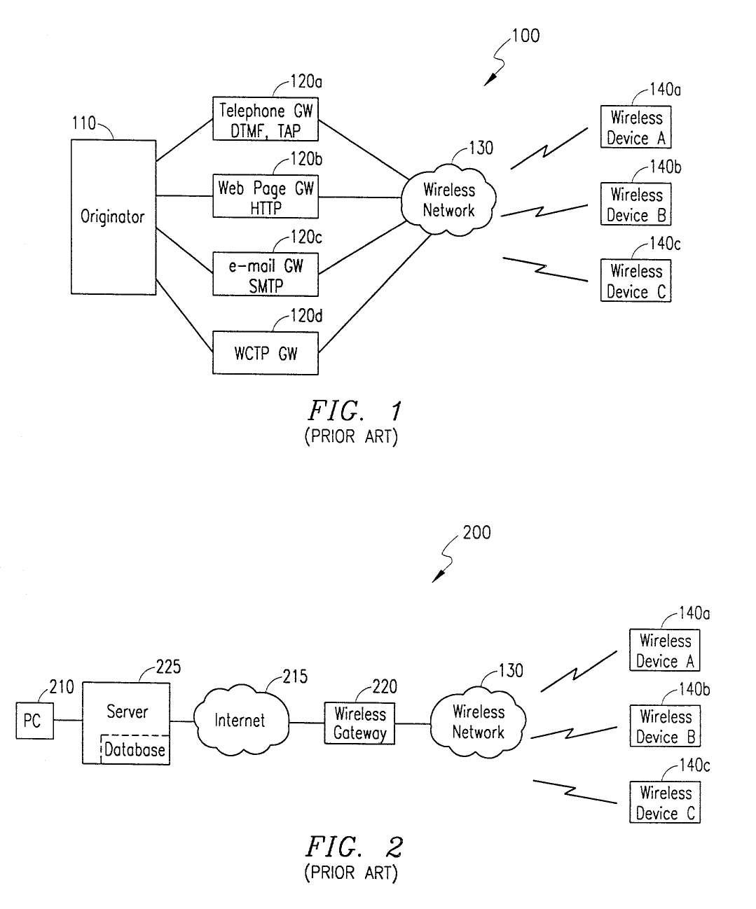

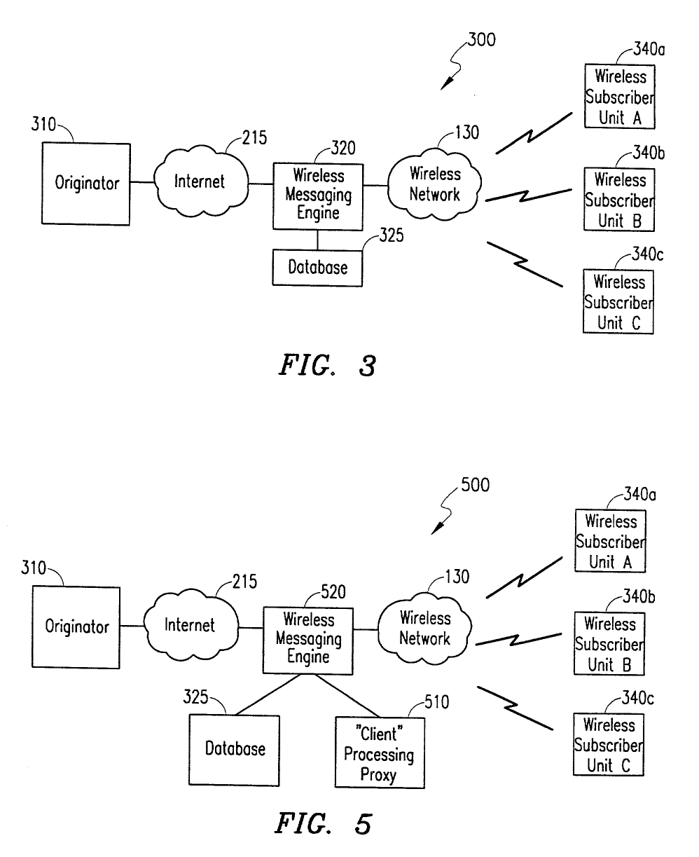

Referring now to FIG. 2, a block diagram of a traditional two-way messaging system 200 is shown. A PC 210 is connected to a server 225 which contains a database acting as a message store for a user of the PC 210. The server 225 is connected to the Internet 215 which is connected to a wireless gateway 220. The wireless gateway 220 is connected to a wireless network 130. Messages received from the Internet 215 are received at the server 225 and stored in the database. The user of the PC 210 retrieves messages from the server 225. Alternately, the user may choose to have his or her messages redirected to a wireless device 140a-140c. In this case messages received at the server 225 are sent to the Internet 215 which sends the message to the wireless gateway 220. The wireless gateway 220 sends the message to the wireless network 130. The wireless network 130 then sends the message to the wireless device 140a-140c associated with the user.

Referring now to FIG. 3, a block diagram of a wireless messaging system 300 in accordance with an embodiment of the present invention is shown. The wireless messaging system 300 provides messaging services to subscribers, which are users that have signed up for messaging services from a wireless service provider. A wireless messaging engine 320 is in communication with the Internet 310 and a wireless network 130. The wireless messaging engine 320 is also in communication with a database 325, which may be integrated with the wireless messaging engine 320 or accessed from another node of the network. The database 325 is used to store information associated with a particular subscriber or a number of subscribers, for example, messages, subscriber profiles and preferences. The wireless network 130 is in communication with at least one wireless subscriber device 340a-340c, such as a pager, two-way messaging device, a cellular telephone, a personal digital assistant (PDA), a handheld PC, etc.

The wireless messaging engine 320 in accordance with the present invention functions as a messaging server for wireless messaging system subscribers. A message originator 310 generates a message addressed to a particular subscriber, for example, a subscriber associated with the wireless subscriber unit 340a-340c which is sent to the Internet 215. The wireless messaging engine 320 receives the message from the Internet 215. Alternately, the wireless messaging engine 320 can receive messages from any of a number of traditional gateways. After determining that the subscriber address is valid, the wireless messaging engine 320 determines the proper routing to the wireless subscriber unit 340, the proper message format or protocol for the particular wireless subscriber unit 340, and handles the delivery of the message or exception conditions. The wireless messaging engine 320 sends the message to the wireless network 130, which sends the message to the wireless subscriber unit 340a-340c.

In accordance with an embodiment of the present invention, the database 325 is used to store, among other things, messages and preference profiles for subscribers and subscriber associated wireless devices. The wireless messaging engine 320 acts as a server for the wireless subscriber unit 340a-340c for e-mail services, information services, and other messaging services. In one embodiment of the present invention, a history of all messages sent and received can be stored in the database along with statistics about messaging, call detail records, billing information, and other information gathered by the wireless messaging engine 320.

The profile information can include information about the capabilities of the wireless subscriber unit 340a-340c as well as preferences for a subscriber associated with a particular wireless subscriber unit 340a-340c. In addition, the profile information can include information about the location of a particular wireless subscriber unit 340a-340c associated with a subscriber within the wireless network 130. Message information can be filtered with relative ease at the transport protocol level and application content level through the use of preference and profile information. As a result, message content verboseness as well as the sending of unnecessary information can be dramatically reduced. For example, state and threading information for e-mail is no longer necessary between an input gateway and the wireless network 130, as the database 325 can maintain all pertinent state and threading information. In addition, unnecessary content in a message received from the Internet 310, such as URLs, still images, audio clips, multimedia files, and other attached or included files, may be removed by the wireless messaging engine 320 before sending the message to the wireless subscriber unit 340a-340c to which the message is addressed. By using the profile and preference information, the wireless subscriber unit 340a-340c is only sent the message content that is desired by the subscriber or is capable of being presented by the wireless subscriber unit 340a-340i c.

In accordance with one embodiment of the present invention, part of the database 325 is used as a message store. The wireless messaging engine 320 maintains a message store associated with each subscriber in the database 325. Messages addressed to a particular subscriber are received at the wireless messaging engine 320 and are stored in the database 325. The stored messages may be stored in their original format, including all original content, for example URLs, attached files, etc., that was removed prior to transmission to the wireless subscriber unit 340a-340c. The subscriber's messaging address can be associated with the wireless messaging engine 320 so that it serves as the subscriber's primary message store. The message store can be accessed from the subscriber's wireless subscriber unit 340a-340c or through the Internet 310, such as through a Web page message interface or a PC-based messaging application.

The wireless messaging engine 320 functions to maintain a virtual presence on the Internet on behalf of the wireless subscribers that it supports. In this way, the wireless messaging engine 320 maintains a permanent presence for a subscriber on the Internet and acts as that individual's message store. Portions of certain messages will be sent to the wireless device following a set of rules as determined by the subscriber. These rules or preferences are maintained in the profile stored in the database 325. Setting or changing these rules can be performed via a Web page that the subscriber logs into via the Internet 215, or using the wireless subscriber unit 340a-340c. In this way the wireless subscriber unit 340 is functioning as a light client because the majority of the processing of messages will be done by the wireless messaging engine 320 with the database 325, and not sent via the wireless network 130 to the wireless subscriber unit 340a-340c for it to process.

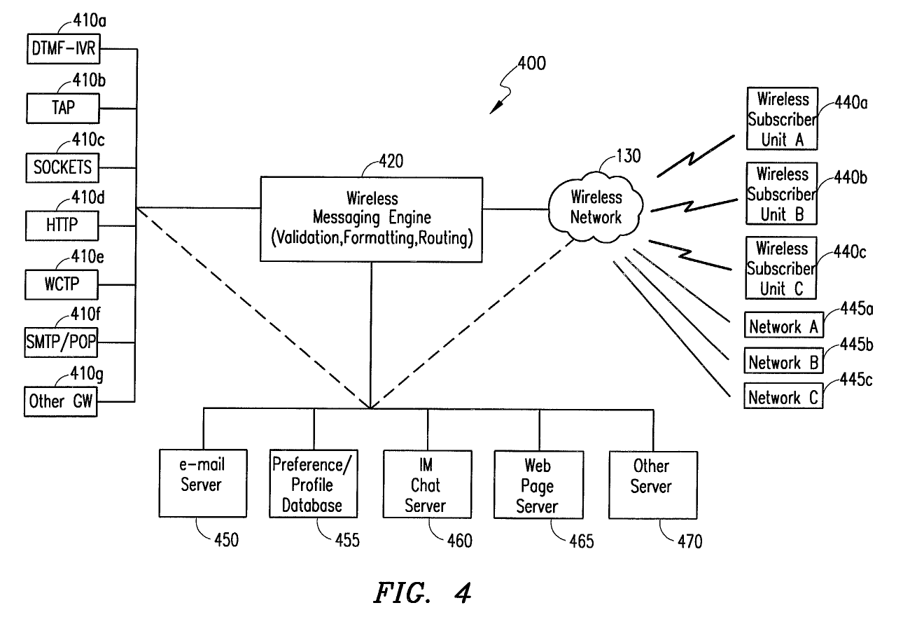

Referring now to FIG. 4, a block diagram of a wireless messaging system 400 in accordance with another embodiment of the present invention is shown. A wireless messaging engine 420 is in communication with a number of well-known messaging gateways including a DTMF-IVR gateway 410a, a TAP gateway 410b, a socket gateway 410c, a HTTP gateway 410d, a WCTP gatew 410e, a SMTP/POP gateway 410f, or any of a number of other well-known gateways 410g. The wireless messaging engine 320 is also in communication with an e-mail server 450, a subscriber preference/profile database 455, an Instant Messaging chat server 460, a Web page server 465, and any of a number of other well-known servers 470. In addition, the wireless messaging engine 320 is in communication with a wireless network 130. The wireless network 130 is in communication with a number of wireless subscriber units 440a-440c and additional networks 445a-445c, for example, other wireless networks.

In accordance with the present embodiment the e-mail server 450 serves as an e-mail storage for messages addressed to a particular wireless subscriber associated with the wireless messaging engine 420. These e-mail messages are then retrieved by the subscriber through the wireless messaging system 420 using a wireless subscriber unit 440a-440c, a messaging gateway 410a-410g, or another network 445a-445c. For example, a subscriber may access a Web page interface using the HTTP gateway 410d to request receipt of his or her e-mail messages. The HTTP gateway 410d sends the request to the wireless messaging engine 420 which retrieves the messages from the e-mail server 450. The wireless messaging engine 420 then sends the messages to the HTTP gateway 410d which delivers the messages to the subscriber to present the messages to the subscriber using the Web page interface. Alternately, e-mail messages may be retrieved by a subscriber directly from the messaging gateways 410a-410g without passing through the wireless messaging engine 420. In addition, the wireless subscriber may optionally access any of the servers through the wireless network directly without passing through the wireless messaging engine 420. The preference and profile database 455 is used to store preference and profile information associated with a particular subscriber as discussed in relation to FIG. 3.

In an e-mail example, the subscriber no longer requires any e-mail account other than the one associated with the wireless messaging engine 420 residing at the e-mail server 450, and messages can be easily sent to and from the Internet in a fully transparent manner. If the wireless subscriber has more than one e-mail address, these multiple addresses can all be consolidated into a single mailbox with the subscriber address associated with the wireless messaging engine 420. Each name, sometimes referred to as screen name, can have its own rules for message disposition per the profile preferences.

In accordance with the present invention, the wireless messaging engine 420 has the capability of maintaining a virtual presence for millions of subscribers, just as an Internet Service Provider (ISP) maintains a virtual presence for millions of wired customers. To illustrate this concept, an e-mail example is referred to again. When a subscriber is away from his or her PC or traveling across the country, he or she will be able to access certain mail messages using a wireless subscriber unit 440a-440c. Once the subscriber returns to his or her PC, all of the messages will continue to be available to a full client messaging application, such as Microsoft Outlook, residing on the PC by connecting to an e-mail server 450 using a messaging gateway, for example a SMTP/POP gateway 410f. Furthermore, the activity conducted via the wireless subscriber unit will be reflected in the messaging application due to the shared database 455, as maintained by the wireless provider.

In accordance with the present invention, an instant messaging (IM) chat server 460 may be associated with the wireless messaging engine 420. The IM chat server allows a subscriber using a wireless subscriber unit 440a to participate in a chat session with other participants that are connected using a messaging gateway 410a-410g, another wireless subscriber unit 440b-440c, or another network 445a-445c. The IM chat server 460 establishes session information when a participant joins the chat session which does not have to be repeated for each message transferred into or out of the session. As is well known in the art, a chat session may be conducted among two or more participants, with chat between with two participants normally referred to as instant messaging. Ad hoc sessions can be created or established to offer chat ‘rooms’ which can be offered on the IM chat server 460 to provide an easy way to establish a community of interest.

Since all participants are connected to the session simultaneously, all participants are aware of each other's messages. In a typical chat client a running accumulation of exchanged messages from each of the participants is shown to all participants. A current input line is displayed for a user to type or otherwise enter a message and send it to the other participants in the chat session. Traditionally, a chat server echoes the sent message back to the sender at the same time as all other participants are sent copies of the message, which serves as a notification to the user that the message was sent. If an error occurs after echoing, a further error message can be displayed.

A problem with a chat server implementation that echoes sent messages to every participant is its inefficiency in bandwidth usage in a wireless environment. It is sufficient for a chat client that has sent a message to receive an acknowledgment of the message having been accepted and relayed to other participants, rather than receiving the whole message again. A more efficient approach provided by the present invention is to modify the client so that it moves the sent message into the accumulated messages when an acknowledgment is received from the chat server that the message was received. This provides for efficient use of airtime, and results in lower latency or faster response from the user's point of view.

In accordance with another embodiment of the present invention, a Web page server 465 may be associated with the wireless messaging engine 420. This provides the capability of wireless Web access to a subscriber using a wireless subscriber unit 440a. The Web page server 465 also allows for the maintaining by the wireless messaging engine 420 of a bookmark file accessible by the wireless subscriber unit 440a containing subscriber created URLs, or URLs contained in received messages. The wireless messaging engine 420 can then access those Web sites and retrieve information for manipulation, formatting and sending to the wireless subscriber unit 440a-440c. It should be understood that any of a number of other servers 470 may be associated with the wireless messaging engine 420 to provide other server services to a wireless subscriber unit 440a, such as an information service providing stock quotes, news, sports scores, airline schedules, etc.

The preference and profile information contained in the preference and profile database 455 can be configured by the subscriber using the wireless subscriber unit 440a or the messaging gateways 410a-410g. Configuration information sent from the messaging gateways 410a-410g may be sent through the wireless messaging engine 420 to the preference and profile database 455, or directly from the messaging gateways 410a-410g to the preference and profile database 455. For example, an email message formatted with preference information may be sent using the SMTP/POP gateway 410f to the preference and profile database 455. It should be understood that many well-known protocols may be used besides POP or SMTP, including IMAP. In another example, the preference information can be changed using a Web page interface using the HTTP gateway 410d. In still another example, the preference information can be changed using a telephone through the DTMP-IVR gateway 410a.

Due to its continuous presence on the Internet, the wireless messaging engine 420 is ideally suited to act as the synchronization point for Personal Information Managers (PIMs) The shared database 455 and servers 450, 455, 460, 465, & 470, allow client applications, such as Microsoft's Outlook, to maintain synchronization to the wireless subscriber unit 440a via the wireless messaging engine's 420 connection to the wireless network 130. The wireless messaging engine 420 creates a method for the maintaining of a plurality of wireless subscribers with a plurality of mail servers and address book servers, which allows the synchronization of wireless and wired messaging applications via the Internet.

Referring now to FIG. 5, a block diagram of a light-client system 500 in accordance with the present invention is illustrated. A wireless messaging engine 320 is in communication with the Internet 215 and a wireless network 130. A message originator 310 is connected to the Internet 215 to send a message to the wireless messaging engine 520. The wireless messaging engine 520 is also in communication with a database 325 and a “client” processing proxy 510. The database 325 and processing proxy 510 may be integrated with the wireless messaging engine 520 or accessed from other nodes of the network. The wireless network 130 is connected to a wireless subscriber device 340a-340c. As discussed in reference to FIG. 3, the database 325 is used to store information associated with a particular subscriber or a number of subscribers, for example, messages, subscriber profiles and preferences. The proxy processor 510 serves to perform the processing of messages which will be sent to the wireless subscriber unit 340a-340c following a set of rules as determined by the subscriber preferences and profile information stored in the database 325. The wireless messaging engine 520, database 325, and proxy processor 510 serve to process information for the wireless subscriber unit 340a-340c, just as the wireless subscriber unit 340a-340c would normally have to perform itself, but much more quickly and efficiently by using land-based high-speed hardware. Only the result is passed to the device formatted for the wireless device.

Preferences from the subscriber profile in the database 325 are used to aid in determining the desired processing and formatting. Subscriber input from the wireless subscriber unit 340a-340c may be used to override the choices made by the proxy processor before the request is sent from the subscriber unit, or in response to processed data having been sent to the subscriber unit. In effect, the wireless provider becomes an application service provider (ASP) for the wireless subscribers.

The implementation of such a system for an e-mail message store provides a dramatic improvement over other commercially available options. Furthermore, it should be understood that similar light-client implementations for instant messaging, information services and custom applications will produce similar improvements.

Although a preferred embodiment of the method and apparatus of the present invention has been illustrated in the accompanying Drawings and described in the foregoing Detailed Description, it is understood that the invention is not limited to the embodiment disclosed , but is capable of numerous rearrangements, modifications, and substitutions without departing from the spirit of the invention as set forth and defined by the following claims.

What is claimed is:

1. A method for operating a wireless gateway, said method comprising the steps of:
receiving, at the wireless gateway, a communication message from a first communication network, the communication message including address information associated with a subscriber;
storing, by the wireless gateway, the communication message, the communication message being stored in association with the subscriber; and
selectively sending, with the wireless gateway using the wireless communication network, at least a portion of the communication message to a wireless device.

2. The method of claim 1, said method further comprising:
selectively sending, with the wireless gateway using the first communication network, at least a portion of the communication message to a first communication device.

3. The method of claim 1, said method further comprising:
storing by the wireless gateway, preference information in association with the subscriber.

4. The method of claim 1, said method further comprising:
formatting, at a processing proxy, the communication message before the step of selectively sending the at least a portion of the communication message to the wireless device.

5. The method of claim 1, said method further comprising:
establishing session information in association with a communication session, the session information providing threading and state information for session participant messages.

6. The method of claim 1, wherein the receiving step further includes validating a subscriber to which the communication message is addressed against stored subscriber validation information.

7. The method of claim 1, wherein the selectively sending step further includes formatting the at least a portion of the communication message in accordance with at least one of wireless device capabilities, and stored preference information associated with the subscriber.

8. The method of claim 1, wherein the selectively sending step further includes routing the at least a portion of the communication message in accordance with stored location information, the stored location information indicating a location of the wireless device within the wireless network.

9. The method of claim 1, wherein the receiving step further includes authenticating an originator of the communication message.

10. The method of claim 1, wherein the at least a portion of the communication message is determined in accordance with stored subscriber preferences.

11. A wireless messaging system, said wireless messaging system comprising:
a first communication network;
a wireless communication network; and
a wireless gateway in communication with said first communication network and said wireless communication network, said wireless gateway receiving, from the first network, a communication message including address information associated with a subscriber, said wireless gateway having a database, the database storing the communication message, the communication message being stored in association with the subscriber, and said wireless gateway capable of selectively sending at least a portion of the communication message to a wireless device using the wireless communication network.

12. The wireless messaging system of claim 11, wherein said wireless gateway is capable of selectively sending, using the first communication network, at least a portion of the communication message to a first communication device.

13. The wireless messaging system of claim 11, wherein the wireless gateway is capable of storing, in the database, preference information in association with the subscriber.

14. The wireless messaging system of claim 11, further comprising:
a processing proxy in communication the wireless gateway, the processing proxy capable of formatting the communication message before selectively sending the at least a portion of the communication message to the wireless device.

15. The wireless messaging system of claim 11, wherein the wireless gateway is further capable of establishing session information in association with a communication session, the session information providing threading and state information for session participant messages.

16. The wireless messaging system of claim 11, wherein the wireless gateway is further capable of validating a subscriber to which the received communication message is addressed against subscriber validation information stored in the database.

17. The wireless messaging system of claim 11, wherein the wireless gateway is further capable of formatting the at least a portion of the communication message in accordance with at least one of wireless device capabilities, and preference information in a profile associated with the subscriber, the preference information being stored in the database.

18. The wireless messaging system of claim 11, wherein the wireless gateway is further capable of routing the at least a portion of the communication message in accordance with location information stored in the database, the location information indicating a location of the wireless device within the wireless network.

19. The wireless messaging system of claim 11, wherein the wireless gateway is further capable of authenticating an originator of the communication message.

20. The wireless messaging system of claim 11, wherein the at least a portion of the communication message is determined in accordance with subscriber preference information stored in the database.

21. An apparatus for wireless messaging, the apparatus comprising:
a first interface in communication with a first communication network;
a second interface in communication with a wireless communication network; and
a wireless gateway in communication with said first interface and said second interface, said wireless gateway receiving, from the first interface, a communication message including address information associated with a subscriber, said wireless gateway having a database, the database storing the communication message, the communication message being stored in association with the subscriber, and said wireless gateway capable of selectively sending at least a portion of the communication message to a wireless device using the wireless communication network.

22. The apparatus of claim 21, wherein said wireless gateway is capable of selectively sending, using the first communication network, at least a portion of the communication message to a first communication device.

23. The apparatus of claim 21, wherein the wireless gateway is capable of storing, in the database, preference information in association with the subscriber.

24. The apparatus of claim 21, further comprising a processing proxy in communication with the wireless gateway, the processing proxy capable of formatting the communication message before selectively sending the at least a portion of the communication message to the wireless device.

25. The apparatus of claim 21, wherein the wireless gateway is further capable of establishing session information in association with a communication session, the session information providing threading and state information for session participant messages.

26. The apparatus of claim 21, wherein the wireless gateway is further capable of validating a subscriber to which the received communication message is addressed against subscriber validation information stored in the database.

27. The apparatus of claim 21, wherein the wireless gateway is further capable of formatting the at least a portion of the communication message in accordance with at least one of wireless device capabilities, and preference information in a profile associated with the subscriber, the preference information being stored in the database.

28. The apparatus of claim 21, wherein the wireless gateway is further capable of routing the at least a portion of the communication message in accordance with location information stored in the database, the location information indicating a location of the wireless device within the wireless network.

29. The apparatus of claim 21, wherein the wireless gateway is further capable of authenticating an originator of the communication message.

30. The apparatus of claim 21, wherein the at least a portion of the communication message is determined in accordance with subscriber preference information stored in the database.
